(19) United States
(12) Patent Application Publication
(10) Pub. No.: US 2012/0154956 A1
(43) Pub. Date: Jun. 21, 2012

(54) Self protected snapback device driven by driver circuitry using high side pull-up avalanche diode

(75) Inventors: Vladislav Vashchenko, Palo Alto, CA (US); Peter J. Hopper, San Jose, CA (US)

(73) Assignee: National Semiconductor Corporation

(21) Appl. No.: 12/928,714

(22) Filed: Dec. 17, 2010

(51) Int. Cl. H02H 7/00

(52) U.S. Cl. 361/1

(57) ABSTRACT

In a power device such as an NLDMOS power array comprising multiple NLDMOS devices, the gates of which are driven by a driver, self protection against overvoltage events is implemented by providing a high side pull-up avalanche diode connected to at least some of the gates of the NLDMOS devices.

### FIELD OF THE INVENTION

The invention relates to power arrays and transistors. In particular it relates to ESD protection of snapback devices.

### BACKGROUND OF THE INVENTION

Power arrays are optimized for switching performance. In the past, self-protection capabilities of power arrays were determined by the doping profiles (which determine the critical avalanche current per micron width), and on-state parameters (normal switching voltage). However, due to non-uniform current distribution even large NLDMOS arrays can have low critical current. For instance National Semiconductor's ABCD5HV version of the LM5008 with large integrated 100V power array having a 60 mm total gate width was used as part of an asynchronous buck switching voltage regulator circuit. Local burnout was observed at 2 kV HBM (human body model) stress. This corresponds to an average current density of only 22 uA per micron width assuming a uniform current distribution. Thus these large arrays often display very low critical avalanche current. Thus the safe operating area (SOA) as defined by the snapback effect of the NLDMOS devices is typically quite small.

### SUMMARY OF THE INVENTION

According to the invention, there is provided a self protected snapback power device, comprising at least one transistor with unsilicided polysilicon control electrode that is driven by a driver, and a first avalanche diode connected between a high voltage node and a first contact that connects directly or indirectly to the polysilicon control electrode to define a distributed resistor between the first contact and the driver. The snapback power device may comprise multiple CMOS transistors or BJTs defining a power array, the transistors defining unsilicided polygates or unsilicided polysilicon base regions. The driver is preferably connected to at least one second contact of one or more of the polygates or unsilicided polysilicon base regions, the at least one second contact being separated from the at least one first contact by at least part of an unsilicided polygate or unsilicided polysilicon base region. The driver may be connected by at least one second contact to each of the polygates or polysilicon base regions of the transistors, and the avalanche diode may be connected by at least one first contact to each of the polygates or polysilicon base regions of the transistors. The driver may be connected to each polygate or polysilicon base region by multiple second contacts, and the first avalanche diode may be connected to each polygate or polysilicon base region by multiple first contacts, all of the first contacts being spaced apart from the second contacts by at least part of one or more polygates or polysilicon base regions. The first contacts may be connected to a first common metal line, and the second contacts may be connected to a second common metal line. The first and second common metal lines may be formed from the same metallization layer. The driver may be connected by second contacts to alternate polygates or polysilicon base region and the avalanche diode may be connected by second contacts to polygates or polysilicon base regions intermediate the gates or base regions to which the first contacts are connected. The driver may be implemented as a first inverter and a second inverter powered by a controlled voltage, and each with an input and an output, the first inverter being connected with its output to the input of the second inverter. The first avalanche diode may be connected between the high voltage node and the input to the first inverter. The driver may be implemented with additional pairs of inverters connected output-to-input. The controlled voltage to the inverters may be provided by an internal VCC regulator or may be defined by a second avalanche diode connected between the high voltage node and sources of the inverters. The first avalanche diode may be connected indirectly to one or more of the polygates or polysilicon base regions by connecting the anode of the first avalanche diode to a control gate of a transistor that is connected between the high voltage node and the one or more of the polygates or polysilicon base region. A resistor may be provided between the anode of the avalanche diode and the one or more polygates or polysilicon base regions. A third avalanche diode may be provided between the one or more polygates or polysilicon base regions and ground to limit the voltage on the one or more polygates or polysilicon base regions.

### BRIEF DESCRIPTION OF THE DRAWINGS

FIG. 1 shows a cross section through a prior art NLDMOS device,

FIG. 2 a top view of a prior art NLDMOS array,

FIG. 3 shows a schematic circuit diagram of one embodiment of the invention,

FIG. 4 shows a top view of one embodiment of an NLDMOS array of the invention,

FIG. 5 shows a schematic circuit diagram of another embodiment of the invention, and

FIGS. 6 to 8 show schematic circuit diagrams of yet other embodiments of the invention.

### DETAILED DESCRIPTION OF THE INVENTION

The present invention provides a way of replacing the pulsed safe operation area (SOA) limited by the snapback effect and therefore subject to local current crowding and burnout, to a pulsed SOA defined by the opening of the array or transistor in the saturation mode. In other words, the present invention provides a way of bringing the one or more transistors, e.g. NDLDMOS devices of an array, into conduction near their saturation mode to avoid local burnout.

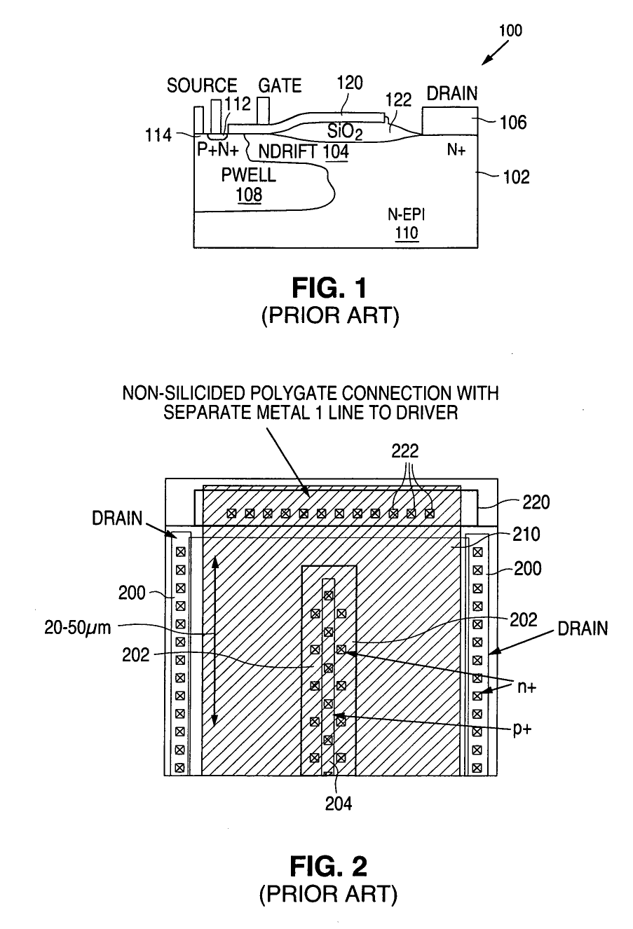

FIG. 1 shows a cross section through a typical NLDMOS device 100. The device includes n+ drain region 102 formed in n-drift region 104 and having drain contact 106. The n-drift region 104 and a p-well 108 are formed in n-epitaxial region 110, and an n+ source region 112 and a p+ region 114 are formed in the p-well 110. Being a lateral device, the polygate 120 extends between the drain region 102 and source region 112, and as shown in FIG. 1, the gate poly extends over the n-drift region 104, spaced from the drift region by a gate oxide 122.

In an NLDMOS array, symmetrically arranged NLDMOS devices are formed side by side as shown in FIG. 2. The drain regions 200 extend on either side of a central source region 202 to define drain fingers of adjacent NLDMOS devices. A central p+ region 204 extends along the middle of the source region 202 to define a source finger on either side of the p+ region 204. The unsilicided gate poly 210 extends between and around the source and drain fingers 200, 202 and is provided with contacts 220 for connecting the gate poly to metal 1 line 222.

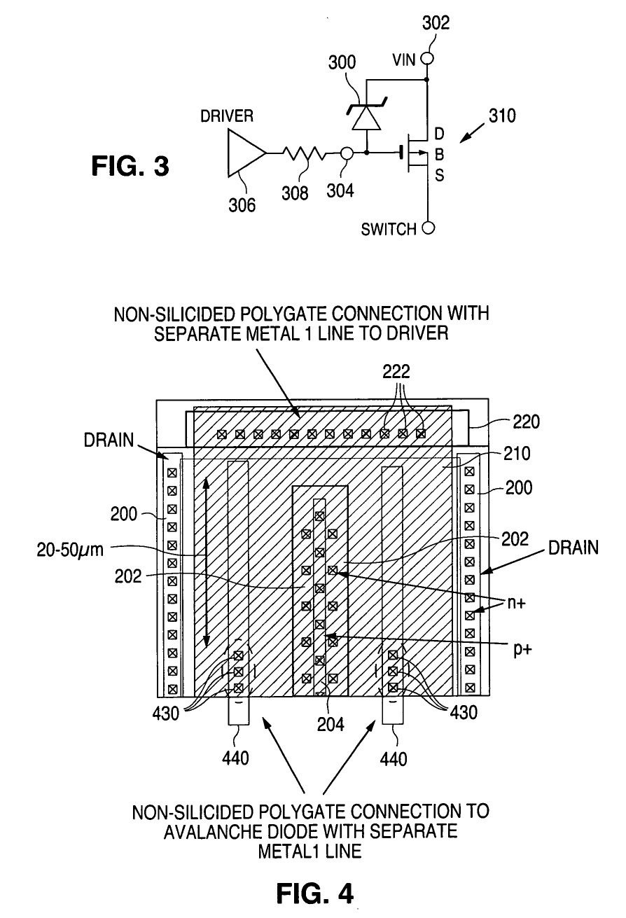

In accordance with the invention, in the case of an overvoltage condition such as an electrostatic discharge (ESD) event, the gate voltage is controlled to bring the NLDMOS devices into conduction close to their saturation voltage. This is achieved by including in the array an avalanche diode such as the diode 300 shown in the embodiment of FIG. 3. The avalanche diode is chose so that during an overvoltage condition, the voltage pulse on the drain node 302 will exceed the breakdown voltage of the avalanche diode. In this embodiment the power array (as depicted by the NLMOS 310) is connected to a high impedance node 304 as defined by the driver 306. Depending on the impedance of the driver 306, a resistive element 308 may be included to increase the impedance at the node 304. By choosing the resistive element 308 to provide asufficiently high impedance at the node 304 current from the node 302 (once the avalanche diode 300 breaks down) is channeled to the gates of the NLDMOS devices instead of passing into the driver. In one embodiment, the distributed resistance of the polygate is utilized to provide the resistance of element 308.

A top view of one such implementation is shown in FIG. 4. For ease of reference, structural elements that are similar to the array shown in FIG. 2, are depicted using the same reference numerals. Thus drain fingers 200 are shown extending on either side of source finger 202. The gate contacts 220 are connected to metal 1 line 222 and in this embodiment provide a contact for a driver such as the driver 306 in FIG. 3. The gate poly 210 in this embodiment is also provided with additional gate contacts 430 between each pair of drain-source fingers, which connect to a separate metal 1 line 440. Since the gate poly is unsilicided and the metal 1 line 222 is separate from the metal 1 line 440, it will be appreciated that the gate poly defines a distribute resistance between the gate contacts 220 and gate contacts 430 to provide a contact node for the avalanche diode (such as avalanche diode 300 in FIG. 3) that is separated from the driver contact by a gate poly resistance.

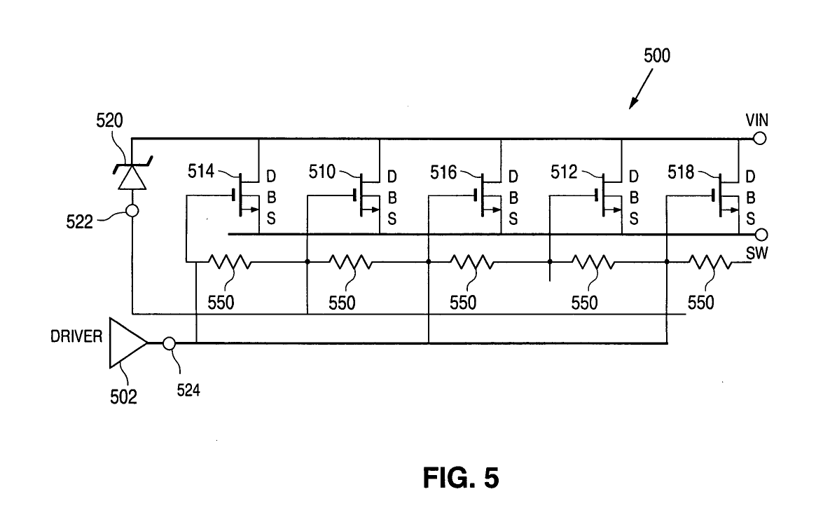

In another embodiment, shown in FIG. 5, in which the power array 500 is connected to a low impedance output driver 502, the gates of alternate NLDMOS devices 510, 512 in the array are connected to the avalanche diode 520, while the low impedance driver is connected to the intermediate NLDMOS devices 514, 516, 518. This configuration provides for additional poly gate material between the node 522 (at the anode of the avalanche diode 520) and the low impedance output node 524 from the driver 502, thereby providing for additional distributed resistance as depicted by the resistive elements 550 in FIG. 5.

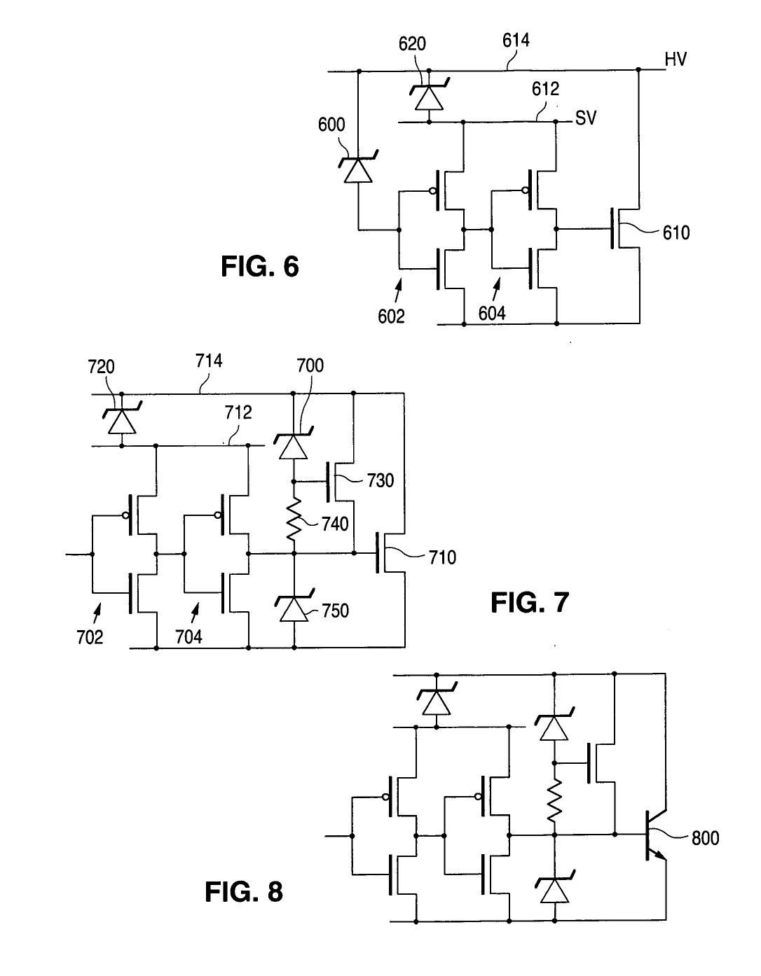

FIG. 6 shows a circuit diagram of yet another embodiment of the invention. Instead of connecting the anode of the avalanche diode 600 to the low impedance output of the driver, the diode is connected to the input of the driver, which in this embodiment is implemented as a pair of inverters 602, 604. Since the driver presents a high impedance input to the avalanche diode 600 a much smaller avalanche diode will suffice in this configuration. It will be appreciated that the additional inverters can be chained together in pairs to increase the input impedance. In this embodiment the driver is connected directly to the gates of the NLDMOS array, which is depicted by NLDMOS 610. The inverters 602, 604 are powered from a 5V supply rail 612. The embodiment of FIG. 6 includes a Zener diode 620 connected between high voltage rail 614 and the supply rail 612 to provide the 5V for the supply rail 612 during an ESD stress. It will be appreciated that insofar as the internal VCC regulator produces 5V VDD during ESD stress, the diode 620 is unnecessary and can be deleted from the circuit.

Another embodiment of the invention is shown in FIG. 7. A high voltage avalanche diode 700 (e.g., 20-100 V avalanche diode) is used to control the gate voltages of the NLDMOS array, depicted by NLDMOS 710. However, in this embodiment a small high voltage NLDMOS 730 is connected between the HV rail 714 and the gate of NLDMOS 710 (array gate). The avalanche diode 700 therefore does not control the NLDMOS array directly but controls the gate of the NLDMOS 730, thereby amplifying the current into the array gate. During an ESD event when the voltage on the high voltage rail 714 (VHV) is greater than the breakdown voltage Vbr of the avalanche diode 700 plus the threshold voltage Vt of the NLDMOS 730, the gate of NLDMOS 730 is pulled up to turn on NLDMOS 730. When VHV is low (in the absence of an ESD event) the small high voltage NLDMOS 730 remains off. A resistor 740 (e.g. 10-100 k) provides a potential difference for creating the threshold voltage to turn on the NLDMOS 730. In order to avoid overloading the array gate during an ESD event, when NLDMOS 730 turns on, this embodiment includes an optional low voltage avalanche diode 750 (e.g. 5-7V) between the array gate and ground in order to clamp the voltage on the array gate. During normal operation the array gate is driven by a driver, which in this embodiment is depicted by the dual inverters 702, 704, which are powered from a 5V rail 712. An optional avalanche diode 720 limits the voltage on the rail 712 during and ESD event. In the above embodiments self protection of an NLDMOS array was discussed. However the invention is not so limited, but extends to self protection of any CMOS arrays, or BJT devices. For example in the case of a BJT the Zener will just provide the base current to the BJT, as is indicated by transistor 800 in FIG. 8.

The invention also extends to self protection of individual snapback devices that are driven by a driver circuit. One such embodiment would be the circuit of FIG. 7, wherein transistor 710 then defines an individual CMOS transistor. Another embodiment would be the circuit of FIG. 8, in which transistor 800 is an individual NPN transistor.

What is claimed is:

1. A self protected snapback power device, comprising
at least one transistor with unsilicided polysilicon control electrode that is driven by a driver, and
a first avalanche diode connected between a high voltage node and a first contact that connects directly or indirectly to the polysilicon control electrode to define a distributed resistor between the first contact and the driver.

2. A self protected snapback power device of claim 1, wherein the snapback power device comprises multiple CMOS transistors or BJTs defining a power array, the transistors defining unsilicided polygates or unsilicided polysilicon base regions.

3. A self protected snapback power device of claim 2, wherein the driver is connected to at least one second contact of one or more of the polygates or unsilicided polysilicon base regions, the at least one second contact being separated from the at least one first contact by at least part of an unsilicided polygate or unsilicided polysilicon base region.

4. A self protected snapback power device of claim 3, wherein the driver is connected by at least one second contact to each of the polygates or polysilicon base regions of the transistors, and the avalanche diode is connected by at least one first contact to each of the polygates or polysilicon base regions of the transistors.

5. A self protected snapback power device of claim 4, wherein the driver is connected to each polygate or polysilicon base region by multiple second contacts, and the first avalanche diode is connected to each polygate or polysilicon base region by multiple first contacts, all of the first contacts being spaced apart from the second contacts by at least part of one or more polygates or polysilicon base regions.

6. A self protected snapback power device of claim 5, wherein the first contacts are connected to a first common metal line, and the second contacts are connected to a second common metal line.

7. A self protected snapback power devicer of claim 6, wherein the first and second common metal lines are formed from the same metallization layer.

8. A self protected snapback power device of claim 5, wherein the driver is connected by second contacts to alternate polygates or polysilicon base regions and the avalanche diode is connected by first contacts to polygates or polysilicon base regions intermediate the polygates or polysilicon base regions to which the second contacts are connected.

9. A self protected snapback power device of claim 1, wherein the driver is implemented as a first inverter and a second inverter powered by a controlled voltage, and each with an input and an output, the first inverter being connected with its output to the input of the second inverter.

10. A self protected snapback power device of claim 9, wherein the first avalanche diode is connected between the high voltage node and the input to the first inverter.

11. A self protected snapback power device of claim 9, wherein the driver is implemented with additional pairs of inverters connected output-to-input.

12. A self protected snapback power device of claim 9, wherein the controlled voltage to the inverters is provided by an internal VCC regulator or is defined by a second avalanche diode connected between the high voltage node and sources of the inverters.

13. A self protected snapback power device of claim 2, wherein the first avalanche diode is connected indirectly to one or more of the polygates or polysilicon base regions by connecting the anode of the first avalanche diode to a control gate of a transistor that is connected between the high voltage node and the one or more of the polygates or polysilicon base region.

14. A self protected snapback power device of claim 13, wherein a resistor is provided between the anode of the first avalanche diode and the one or more polygates or polysilicon base regions.

15. A self protected snapback power device of claim 12, wherein a third avalanche diode is provided between the one or more polygates or polysilicon base regions and ground to limit the voltage on the one or more polygates or polysilicon base regions.
